(19) United States
(12) Patent Application Publication
(10) Pub. No.: US 2015/0285199 A1
(43) Pub. Date: Oct. 8, 2015

(54) FUEL INJECTOR AND FUEL-INJECTION SYSTEM HAVING A FUEL INJECTOR

(71) Applicant: ROBERT BOSCH GMBH, Stuttgart (DE)

(72) Inventors: Marco Vorbach, Freiberg (DE); Christoph Haible, Tamm (DE)

(21) Appl. No.: 14/440,715

(22) PCT Filed: Sep. 9, 2013
(86) PCT No.: PCT/EP2013/068560

§ 371 Date: May 5, 2015

(30) Foreign Application Priority Data
Nov. 9, 2012 (DE) 10 2012 220 491.1

(51) Int. Cl. F02M 55/00; F02M 51/06; F02M 69/50; F02M 55/04

(52) U.S. Cl. CPC F02M 55/008; F02M 55/04; F02M 51/061; F02M 69/50

(57) ABSTRACT

A fuel injector for a fuel-injection system of an internal combustion engine includes: a housing; a valve needle provided in the housing; a fuel inlet; and a valve needle extension which is at least indirectly actuatable by the valve needle. An opening stroke of the valve needle renders the valve needle extension movable in the region of the fuel inlet. In response to the opening stroke of the valve needle, a valve needle-distal end of the valve needle extension is movable through a through bore in a wall of a fuel distributor of the fuel-injection system.

### BACKGROUND OF THE INVENTION

1. Field of the Invention

The present invention relates to a fuel injector that is used, in particular, for fuel-injection systems of internal combustion engines, and to a fuel-injection system having such a fuel injector. In particular, the present invention is directed to the field of fuel-injection systems of mixture-compressing internal combustion engines having externally supplied ignition.

2. Description of the Related Art

A fuel injection device having at least one fuel injector and a fuel rail having at least one connecting pipe are known from the published German Patent Application document DE 10 2007 049 357 A1. The fuel injector is introduced here into a receiving bore of the connecting pipe. The fuel manifold has an outflow orifice for supplying fuel to the fuel injector. Disposed between the fuel injector and the fuel rail and connecting the two is a pressure waveguide, which is provided in a way that allows dynamic pressure fluctuations in the fuel injector to be substantially routed past the volume of the receiving bore of the connecting pipe. Formed in this case in the region of the outflow orifice of the fuel rail, which the pressure waveguide passes through, is an annular leakage gap that permits a slow buildup and reduction of pressure in the connecting pipe in accordance with the system pressure, thus a static pressure equalization, between the pressure waveguide and the wall of the outflow orifice.

It is a disadvantage of the fuel injector device known from the published German Patent Application document DE 10 2007 049 357 A1 that the pressure waveguide acts as a throttle which, at a given size of the outflow orifice, adversely affects the quantity of fuel to be supplied per unit of time.

### BRIEF SUMMARY OF THE INVENTION

The fuel injector according to the present invention and the fuel-injection system according to the present invention advantageously provide an improved method of functioning. In particular, it is possible to provide an improved vibration damping between the fuel injector and a fuel rail. Moreover, it is possible to reduce compressive oscillations that influence a fuel quantity variance.

In accordance with the present invention, the valve needle extension is at least indirectly actuatable by the valve needle. This includes both an indirect, as well as a direct actuation of the valve needle extension by the valve needle. One or a plurality of interposed elements may be used for the indirect actuation, a purely mechanical transmission of force being preferably realized. Particularly advantageous, however, is an embodiment where the valve needle extension may be directly actuated by the valve needle. This reduces the number of required parts and ensures a reliable operation. Moreover, substantial rigidity may be hereby achieved in the transmission of force.

The fuel inlet is advantageously provided at a nozzle-distal end of the fuel injector housing. This makes possible a linear transmission of force from the valve needle to the valve needle extension. In particular, the valve needle and the valve needle extension may be configured on a common axis, namely the longitudinal axis of the valve needle.

It is also advantageous that a receiving sleeve be provided at a nozzle-distal end of the valve needle, that a valve needle-proximal end of the valve needle extension be inserted into the receiving sleeve, and that the valve needle extension be connected via the receiving sleeve to the nozzle-distal end of the valve needle. The receiving sleeve may be joined, for example, by welding or brazing to the nozzle-distal end of the valve needle and/or to the valve-proximal end of the valve needle extension. A substantial mechanical stability is thereby ensured. This makes possible a reliable positioning of the valve needle extension, in particular an axial orientation of the valve needle extension relative to the longitudinal axis of the valve needle.

Moreover, it is advantageous that the opening stroke of the valve needle renders the valve needle extension movable in the region of the fuel inlet in such a way that a throttling effect at the fuel inlet for a fuel conveyed via the fuel inlet into the housing is increased in comparison to a closed position of the valve needle. In this case, it is also advantageous that, in the closed position, the valve needle extension does not contribute to the throttling effect at the fuel inlet for the fuel conveyed via the fuel inlet into the housing. Thus, in the closed position of the valve needle, a minimum throttling effect is realized, so that the fuel pressure required for the injection, i.e., typically the next injection or the next injection procedure, may be rapidly built up. On the other hand, if the nozzle needle is opened in the open position, the throttling effect is amplified, thereby forming a throttling point and making it possible to induce a hydraulic vibrational decoupling. The throttling which, as a result, is not constantly present, thus permits a better and more rapid filling, as well as an improved pressure equalization of the pressurized parts.

The valve needle extension is also advantageously configured to be pin-shaped. Upon opening of the fuel injector, the pin-shaped valve needle extension may advantageously be driven out of the nozzle-distal end of the housing of the fuel injector. The opening stroke of the valve needle advantageously renders the valve needle extension movable in the region of the fuel inlet in a way that allows the valve needle-distal end of the valve needle extension to be slid out of the housing. A properly dimensioned length of the valve needle extension allows an adaptation to be made to the particular application case. An extensive range of application may be hereby realized, where necessary with minor modifications.

In particular, a through bore may be configured in the wall of the fuel distributor; in response to the opening stroke of the valve needle, a needle-distal end of the valve needle being movable in and optionally through the through bore of the wall of the fuel distributor. In this connection, a pin-shaped valve needle extension may, in particular, have a shape long enough to allow it to move in the open state of the fuel injector in, respectively through the through bore in the wall of the fuel distributor. At the same time, the need for a separate guidance for the valve needle extension may be eliminated by a suitable connection of the valve needle extension to the valve needle. Depending on the particular application, however, a guidance for the valve needle extension is also possible, if indicated, in particular relative to a longitudinal axis of the valve needle.

During fuel-injection processes, hydraulic vibrations, which occur within the fuel injectors of the fuel-injection system due to the dynamic displacement of the valve needle, may, in principle, also be transmitted to the fuel distributor, in particular to a fuel manifold. When these vibrations pass from the particular fuel injector over into the fuel distributor, then this negatively affects sound emissions and, thus, the noise of the fuel-injection system. Thus, such undesired effects may be reduced by the present invention, making it possible to decrease the hydraulically generated vibrations during the injection processes. At the same time, a cost-effective realization is possible since no additional damping components are required at the fuel distributor or the fuel injector. To further enhance noise reduction, however, a combination that includes additional damping components is also optionally conceivable.

Thus, a throttling may be used, for example, to hydraulically decouple the vibrations that are generated. In this case, however, the throttling is not achieved by permanently installing a constriction, but rather dynamically produced each time by the described embodiment, even during the opening stroke of the valve needle. This partial throttling takes place by the valve needle extension plunging into the region of the fuel inlet, more specifically into an inflow geometry of the fuel injector, in response to the fuel injector opening, thereby producing the throttling point and thus inducing a hydraulic vibrational decoupling that terminates itself again in response to closing. Since the throttling conditions change with the opening and closing of the fuel injector and because the throttling is not constantly present, a better and more rapid filling and pressure equalization of the pressurized components are additionally provided.

It is, thus, advantageous that the partial throttling not only has the purpose of reducing noise, but also of reducing compressive oscillations that have an effect on a fuel quantity variance. By reducing compressive oscillations and pressure pulsations in this manner, a more uniform supplying of the fuel quantity from the fuel injector is obtained from injection to injection. Thus, emissions, fuel consumption and power output may be controlled more effectively.

### BRIEF DESCRIPTION OF THE DRAWINGS

FIG. 1 schematically shows a fuel injector in accordance with an exemplary embodiment of the present invention.

FIG. 2 shows a fuel-injection system having the fuel injector illustrated in FIG. 1 in a schematic sectional view in excerpted form in accordance with the exemplary embodiment of the present invention, in a closed state.

FIG. 3 shows the fuel-injection system illustrated in FIG. 2, having the fuel injector in accordance with the exemplary embodiment of the present invention, in an open state.

### DETAILED DESCRIPTION OF THE INVENTION

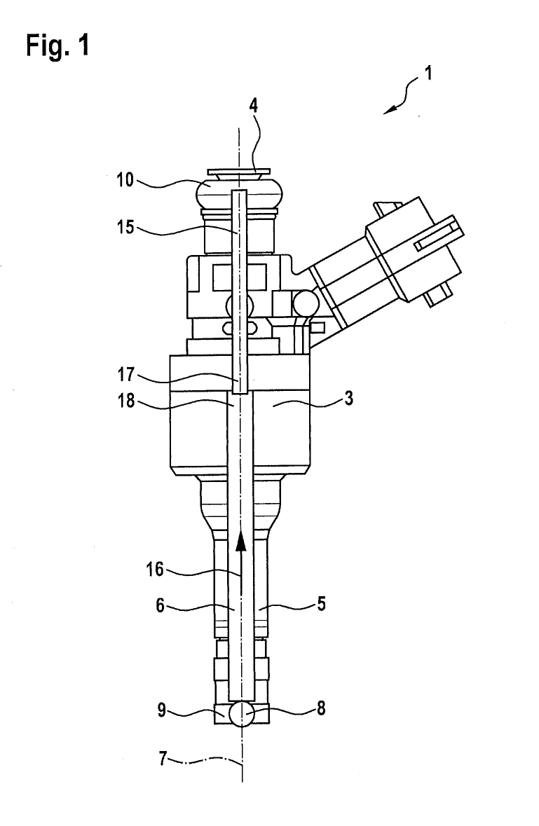

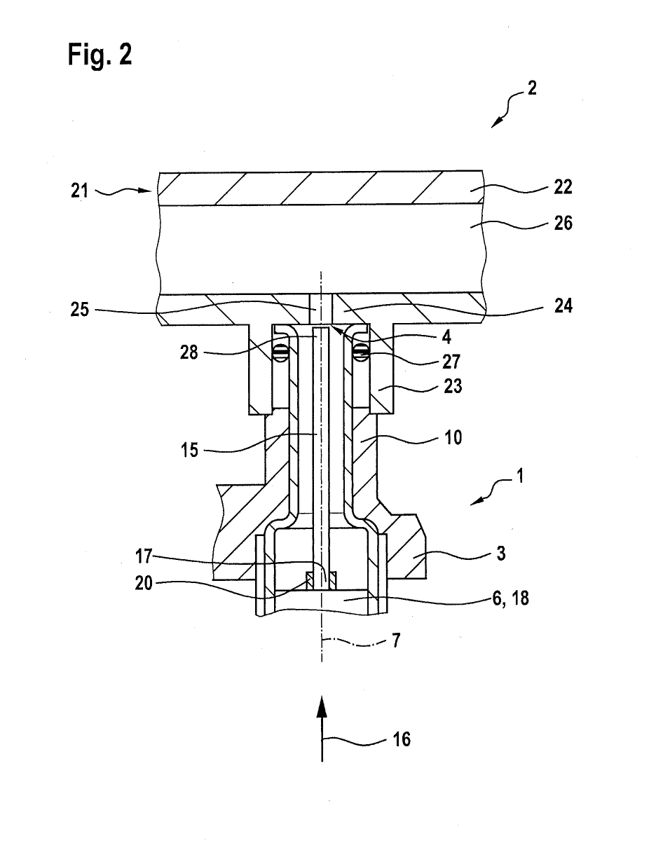

FIG. 1 shows a fuel injector 1 in a schematic representation in accordance with an exemplary embodiment. Fuel injector 1 is used, in particular, for a fuel-injection system 2 (FIG. 2) of internal combustion engines. Fuel injector 1 may be specifically configured here for high-pressure injection in the case of internal combustion engines. Such an internal combustion engine may be a mixture-compressing internal combustion engine having externally supplied ignition, for example. However, fuel injector 1 according to the present invention and fuel-injection system 2 according to the present invention are also suited for other application cases.

Fuel injector 1 has a housing 3 that may be configured as a multipart housing 3. A fuel inlet 4 is provided on housing 3. Housing 3 includes a nozzle body 5, in which a valve needle 6 is guided along an axis 7, which is longitudinal axis 7 of valve needle 6. In this exemplary embodiment, valve needle 6 extends along longitudinal axis 7 through nozzle body 5 and partially through housing 3. A schematically illustrated valve-closure member 8 is configured at valve needle 6. Valve-closure member 8 of valve needle 6 is disposed at a nozzle-proximal end 9 of housing 3.

In this exemplary embodiment, fuel inlet 4 is disposed at a nozzle-distal end 10 of housing 3.

Fuel injector 1 has a valve needle extension 15, which is oriented on longitudinal axis 7 of valve needle 6. During operation, valve needle 6 is actuatable in an opening direction 16 along longitudinal axis 7. Such an actuation may take place via a magnetic actuator, for example. An opening stroke of valve needle 6 is hereby induced. In response to the opening stroke of valve needle 6, valve needle extension 15 is moved in the region of fuel inlet 4. In this exemplary embodiment, valve needle-proximal end 17 of valve needle extension 15 rests against a nozzle-distal end 18 of valve needle 6. This makes possible a direct actuation of valve needle extension 15 by valve needle 6. Thus, the opening stroke of valve needle 6 in opening direction 16 effects a stroke of equal magnitude of valve needle extension 15 at fuel inlet 4.

FIG. 2 shows fuel-injection system 2 having fuel injector 1 illustrated in FIG. 1 in a schematic sectional view in excerpted form in accordance with the exemplary embodiment in a closed state of valve needle 6 of fuel injector 1. A receiving sleeve 20 is provided at a nozzle-distal end 18 of valve needle 6. Valve needle-proximal end 17 of valve needle extension 15 is inserted into receiving sleeve 20. Receiving sleeve 20 may be joined, for example, by welding or brazing to nozzle-distal end 18 of valve needle 6. Correspondingly, a connection of valve needle-proximal end 17 of valve needle extension 15 to receiving sleeve 20 may also be accomplished by welding or brazing. However, end 17 of valve needle extension 15 may also be pressed into receiving sleeve 20. Thus, valve needle extension 15 is reliably connected via receiving sleeve 20 to nozzle-distal end 18 of valve needle 6.

An orientation of valve needle extension 15 relative to longitudinal axis 7 of valve needle 6 is achieved by this connection of valve needle extension 15 to valve needle 6. In this exemplary embodiment, valve needle extension 15 is disposed on longitudinal axis 7 of valve needle 6. Therefore, there is no need for an additional guidance of valve needle extension 15.

Valve needle extension 15 has a pin shape.

Moreover, fuel-injection system 2 has a fuel distributor 21. In this exemplary embodiment, fuel distributor 21 includes a manifold 22 and a connecting piece 23. At the same time, a multipart embodiment is possible. Connecting piece 23 may have a cup shape, for example. Thus, in this exemplary embodiment, fuel distributor 21 is configured as a fuel manifold 21.

Manifold 22 of fuel distributor 21 features a wall 24. Configured in wall 24 of manifold 22 in the region of connecting piece 23 is a through bore 25. During operation, highly pressurized fuel may be conveyed from a fuel space 26 formed in the interior of manifold 22 via through bore 25 into fuel inlet 4 at nozzle-distal end 10 of housing 3. For sealing purposes, a sealing ring 27 is provided in this case between connecting piece 23 and fuel injector 1.

In the closed state of valve needle 6 shown in FIG. 2, a valve needle-distal end 28 of valve needle extension 15 is spaced apart somewhat from through bore 25 of manifold 22. This ensures that valve needle extension 15 does not cause a throttling effect for the supplied fuel. Thus, in the closed position, valve needle extension 15 does not, at least virtually does not contribute to the throttling effect at fuel inlet 4 for the fuel conveyed via fuel inlet 4 into housing 3.

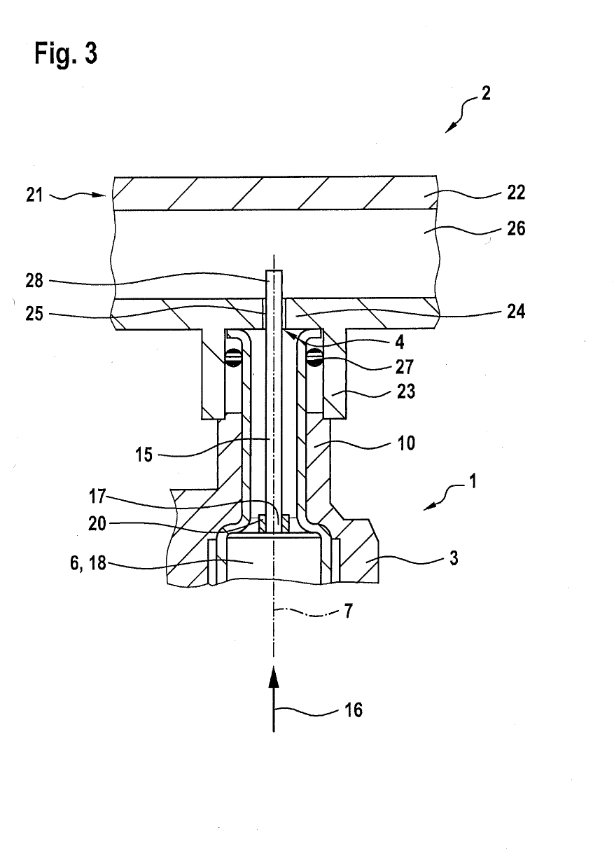

In a schematic sectional view in excerpted form, FIG. 3 shows fuel-injection system 2 illustrated in FIG. 2 having fuel injector 1 and fuel distributor 21 in accordance with the exemplary embodiment in an open state of valve needle 6 of fuel injector 1. In comparison to the closed position of valve needle 6 shown in FIG. 2, valve needle 6 is now displaced by a certain opening stroke in opening direction 16. This directly induces a displacement of equal magnitude of valve needle extension 15 in opening direction 16. During the opening movement, valve needle-distal end 28 of valve needle extension 15 hereby initially reaches into through bore 25. In the position shown in FIG. 3, valve needle-distal end 28 of valve needle extension 15 even extends through the through bore 25 of wall 24 of manifold 22.

Therefore, the result in the open state is that the fuel supplied at fuel inlet 4 is throttled by valve needle extension 15. This is because, in response to the opening stroke of valve needle 6, valve needle extension 15 is moved in the region of the fuel inlet 4 in a way that increases the throttling effect at fuel inlet 4 for the fuel that is conveyed via fuel inlet 4 into housing 3 in comparison to the closed position of valve needle 6. In this exemplary embodiment, valve needle extension 15 is pushed out of nozzle-distal end 10 of housing 3 by the opening stroke of valve needle 6.

Since valve needle 6 is configured as an inwardly opening valve needle 6 of fuel injector 1, valve needle extension 15 is pushed directly out of housing 3 by the opening of valve needle 6. Thus, a simple mechanical design is possible since there is no need to reverse the movement.

The present invention is not limited to the exemplary embodiment described hereinabove.

1-10. (canceled)

11. A fuel injector for a fuel-injection system of an internal combustion engine, comprising:
a housing;
a valve needle provided in the housing;
a fuel inlet; and
a valve needle extension at least indirectly actuatable by the valve needle, wherein an opening stroke of the valve needle renders the valve needle extension movable in the region of the fuel inlet.

12. The fuel injector as recited in claim 11, wherein the fuel inlet is provided at a nozzle-distal end of the housing.

13. The fuel injector as recited in claim 12, wherein the valve needle extension is directly actuatable by the valve needle.

14. The fuel injector as recited in claim 12, wherein:
a receiving sleeve is provided at a nozzle-distal end of the valve needle;
a valve needle-proximal end of the valve needle extension is inserted into the receiving sleeve; and
the valve needle extension is connected via the receiving sleeve to the nozzle-distal end of the valve needle.

15. The fuel injector as recited in claim 12, wherein the opening stroke of the valve needle renders the valve needle extension movable in the region of the fuel inlet in such a way that a throttling effect at the fuel inlet for a fuel conveyed via the fuel inlet into the housing is increased in comparison to a closed position of the valve needle.

16. The fuel injector as recited in claim 15, wherein, in the closed position, the valve needle extension substantially does not contribute to the throttling effect at the fuel inlet for the fuel conveyed via the fuel inlet into the housing.

17. The fuel injector as recited in claim 15, wherein the valve needle extension is at least substantially configured in a pin shape.

18. The fuel injector as recited in claim 12, wherein the opening stroke of the valve needle renders the valve needle extension movable in the region of the fuel inlet in a way that allows a valve needle-distal end of the valve needle extension to be slid out of the housing.

19. A fuel-injection system for an internal combustion engine, comprising:
a fuel injector having:
a housing;
a valve needle provided in the housing;
a fuel inlet; and
a valve needle extension at least indirectly actuatable by the valve needle, wherein an opening stroke of the valve needle renders the valve needle extension movable in the region of the fuel inlet; and
a fuel distributor, wherein the fuel inlet for the fuel injector is configured at least one of at a connecting piece of the fuel distributor and at a wall of the fuel distributor.

20. The fuel-injection system as recited in claim 19, wherein a through bore is configured in the wall of the fuel distributor, and, in response to the opening stroke of the valve needle, a valve needle-distal end of the valve needle extension is movable in and optionally through the through bore of the wall of the fuel distributor.
